(19) United States
(12) Patent Application Publication
(10) Pub. No.: US 2016/0091893 A1
(43) Pub. Date: Mar. 31, 2016

(54) DEVICE FOR MONITORING THE HEALTH STATUS OF A LIMITED LIFE CRITICAL SYSTEM COMPRISING A DATA DISPLAYING UNIT

(71) Applicant: MBDA ITALIA S.P.A., Roma (IT)

(72) Inventor: LUCA BANCALLARI, LERICI (LA SPEZIA) (IT)

(21) Appl. No.: 14/892,364

(22) PCT Filed: Apr. 15, 2014
(86) PCT No.: PCT/EP2014/057610

§ 371 Date: Nov. 19, 2015

(30) Foreign Application Priority Data
May 20, 2013 (IT) RM2013A000297

(51) Int. Cl. G05B 23/02; G05B 15/02

(52) U.S. Cl. CPC G05B 23/027; G05B 15/02

(57) ABSTRACT

A device for monitoring the health status of a limited life critical system, comprising: at least one measurement sensor adapted to measure a magnitude adapted to affect the health status of the critical system; at least one processing unit (13) operatively connected to the sensor (S1-S6); at least one memory adapted to store said digital data; a communication interface adapted to transmit said stored digital data; a data displaying unit, comprising: a bistable display, operatively connected to the processing unit and adapted to locally display data relative to the health status of the critical system and/or data relative to said magnitude.

The present disclosure relates to the technical field of monitoring systems, and it particularly relates to a device for monitoring the health status of a limited life critical system comprising a data displaying unit.

Critical systems are defined those systems that, in the case of an operative failure, may cause severe consequences, such as:

death or severe risks to people;

loss or severe damaging of means and material;

severe environmental damages.

For example, in the case that the critical system is represented by a weapon, such system can be defined as critical, since a malfunctioning thereof may jeopardize a military mission, hence the life of people related to it.

It is known that there is a series of external factors that degrade the performance of a system or a device, thereby altering its health status, even if it is not used. Such degradation is referred to as ageing.

The above-mentioned factors, which may act individually, or in a mutual combination, are represented, for example, by storage temperature, humidity, vibrations or mechanical shocks.

The critical systems, exactly in view of the consequences related to a possible malfunctioning thereof, are limited life system, since they have a life duration within which the degradation remains within accepted limits.

Based on statistical considerations, it is possible to estimate predictively the health status and the life duration of a critical system, for example, in order to program the replacement of the systems at the end of their life duration and/or to avoid using systems beyond their life duration. It shall be apparent that the above-mentioned statistical approach is not an optimal one, first of all, because it requires the provision of suitable and wide margins in order to ensure safety requirements, secondly because it cannot take into account particularly exceptional circumstances which a critical system may be subjected to. Furthermore, the above-mentioned statistical approach requires that long and expensive test procedures are carried out.

The object of the present disclosure is to provide a device that allows monitoring in real time the health status of a limited life critical system and that allows locally displaying data or information relative to the above-mentioned health status of the critical system.

Such an object is achieved by a monitoring device as generally defined in claim 1. Preferred and advantageous embodiments of the above-mentioned device are defined in the appended dependent claims.

The invention will be better understood from the following detailed description of a particular embodiment, given by way of example, and, therefore, being not limiting at all, with reference to the appended drawings, in which:

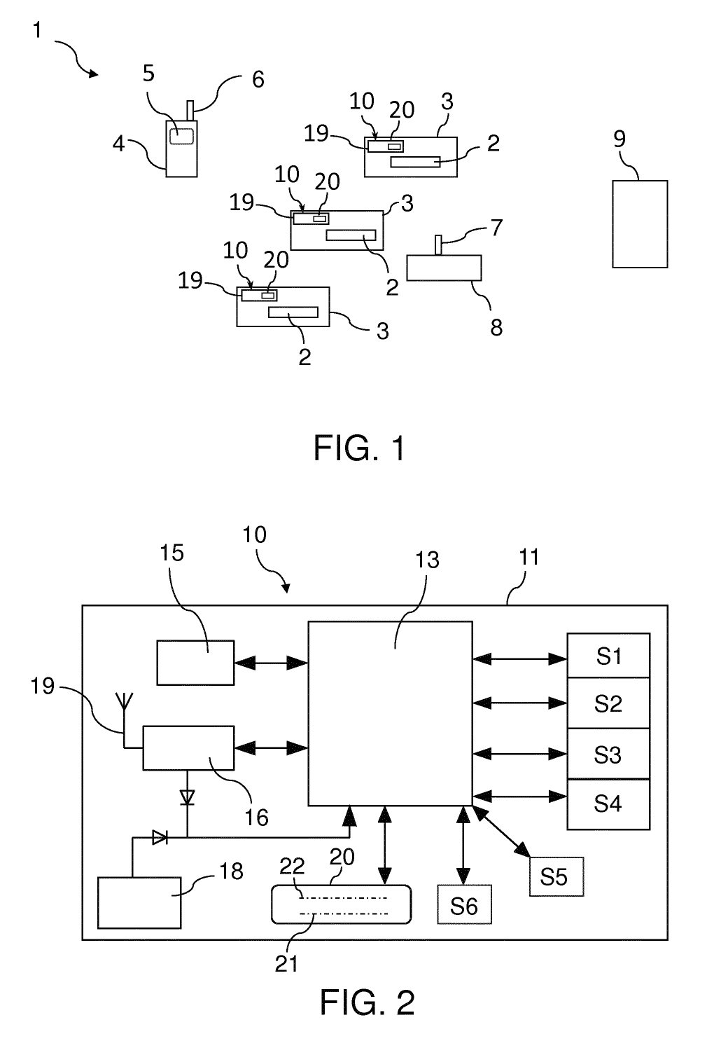

FIG. 1 shows an exemplary block diagram of a monitoring system comprising a monitoring device intended for monitoring the health status of a critical system; and

FIG. 2 shows an exemplary block diagram of the monitoring device of FIG. 1.

In the Figures, similar or like elements will be indicated by the same reference numerals.

In FIG. 1, a non-limiting embodiment of a system 1 for monitoring in real time the health status of a critical system 2 is schematically shown.

In the particular example illustrated, without for this introducing any limitations, the monitoring system 1 is intended for monitoring the health status of a plurality of critical systems 2, which represent, for example, munitions 2 within a storage warehouse. In the illustrated example, each of said munitions 2 is housed in a corresponding container 3. In accordance with an embodiment, the above-mentioned containers 3 are pressurized containers, so that the pressure therein may be kept above the atmospheric pressure.

The containers 3 comprise a containment body to which corresponding monitoring devices 10 are associated, and more precisely mechanically coupled. In accordance with an embodiment, each monitoring device 10 comprises a device body 19 applied to one of the walls of the containment body of the respective container 3. For example, the device body 19 is applied to the container 3 so as to obstruct a special opening obtained in a wall of the container 3 containment body. The monitoring device 10 is provided with a local data displaying unit 20, in other terms, a display 20, which is visible from the outside of the device body 19. In the particular example illustrated, the monitoring system 1 comprises a mobile data collection terminal 4, for example, a handheld device provided with a display 5 and an antenna 6, adapted to query from remote the monitoring devices 10 associated to the corresponding munitions 2 and/or adapted to receive data autonomously transmitted by the monitoring devices 10. Alternatively, or in addition, at least one fixed collection mobile station 8 may be provided, for example provided with an antenna 7, which is adapted to query from remote the monitoring devices 10 and/or which is adapted to receive data autonomously transmitted by the monitoring devices 10.

In accordance with an embodiment, the data collection mobile device 4 and/or the fixed collection mobile station 8 are configured to transmit to a remote server 9 the information acquired from the monitoring devices 10, for example, to transmit such information onto a remote logistic management database.

In accordance with an embodiment, the mobile data collection terminal 4 and/or the fixed collection mobile station 8 are RFID reader devices (Radio Frequency IDentification devices) or similar devices. In alternative embodiments, the mobile data collection terminal 4 and/or the fixed collection mobile station 8 comprise radio interfaces of different types, for example: ZigBee or Wi-Fi (for example in accordance with the standard IEEE 802.11) or of the Smart Transducer type (for example, in accordance with the standard IEEE 1451).

Regarding the possible critical systems 2 to be monitored, it shall be apparent that these systems may include mechanical, electronic, electro-mechanical devices, optionally comprising also chemicals such as, for example, explosives, propellants, etc.

In FIG. 2, a functional block diagram of an embodiment of a device 10 for monitoring the health status of the associated limited life critical system 2 is shown.

The monitoring device 10 comprises at least one measurement sensor S1-S6 adapted to measure a magnitude adapted to affect the health status of the critical system 2, by outputting an electric signal carrying information relative to such magnitude. In accordance with an embodiment, the above-mentioned measurement sensor S1-S6 is a temperature sensor. In accordance with an embodiment, the above-mentioned sensor S1-S6 is a humidity sensor. In accordance with a further embodiment, the above-mentioned sensor S1-S6 is a vibration and/or mechanical shock sensor. In accordance with a further embodiment, the above-mentioned sensor S1-S6 is a pressure sensor. In accordance with an embodiment, the monitoring device 10 comprises a plurality of measurement sensors S1-S6 of different kinds, for example, two or more of the following sensors; a temperature sensor S1, a humidity sensor S2, a vibration sensor S3, for example, an acceleration sensor S4, a shock sensor S5, a pressure sensor S6. Henceforth in the present disclosure, reference will be made, without for this introducing any limitations, to the case where the monitoring device comprises a plurality of measurement sensors S1-S6.

The monitoring device 10 further comprises at least one processing unit 13, which is operatively connected to the measurement sensors S1-S6 and adapted to receive and sample the electric signals provided by the sensors S1-S6 to provide digital data related to the magnitudes measured by the measurement sensors S1-S6. For example, the above-mentioned processing unit 13 comprises a microcontroller, and more preferably a low consumption microcontroller.

The monitoring device 10 further comprises at least one memory 15 adapted to store the digital data sampled by the processing unit 13 and/or digital data obtained by the processing unit 13 by processing said sampled digital data. In the non-limiting example illustrated in FIG. 2, the above-mentioned memory 15 is represented as being external to the processing unit 13. In variant embodiment, such memory 15 could be internal to the processing unit 13, or multiple memory units could be provided, for example, an internal memory unit and an external memory unit.

The monitoring device 10 comprises a power supply system 18 of the processing unit 13. Such power supply system 18 can be also intended to directly or indirectly supply (in the illustrated example, by the processing unit 13) the measurement sensors S1-S6, in the case that such sensors S1-S6 require, for the operation thereof, a power supply source. In accordance with an embodiment, the above-mentioned power supply system 18 comprises a battery. In accordance with a further embodiment, the above-mentioned power supply system 18 comprises an energy harvesting device, internally or externally to the processing unit 13, for example adapted to transform mechanical vibrations into electric power. In accordance with a further embodiment, the above-mentioned power supply system 18 comprises a device adapted to convert a radiofrequency electromagnetic radiation into electric power, by exploiting the technique referred to as Wireless Power Transmission (WPT).

The monitoring device 10 comprises a wireless communication interface 16 for the radio transmission of the stored digital data. In accordance with an embodiment, the wireless communication interface 16 comprises an active or passive RFID transponder 16 adapted to receive a request from an external query RFID device, for example from the mobile data collection terminal 4 and/or the fixed collection mobile station 8, and to provide as a reply the stored digital data. In alternative embodiments, the mobile data collection terminal 4 and/or the fixed collection mobile station 8 comprise radio interfaces of a different type, for example: ZigBee or Wi-Fi (for example, in accordance with the standard IEEE 802.11) or of the Smart Transducer type (for example, in accordance with the standard IEEE 1451). In these embodiments, it is possible to provide for the monitoring devices 10 to autonomously transmit the stored data to the mobile data collection terminal 4 and/or the fixed collection mobile station 8. In this embodiment, it is further possible to provide for the monitoring devices 10 to be connected on the whole as a network of sensors, functionally representing nodes of a network of sensors. In such a case, the above-mentioned nodes 10 may form one or more networks that are adapted to reconfigure autonomously. It is possible to make so that the nodes 10 may mutually communicate autonomously, exchanging information and ‘speaking’ to each other. For example, in the case of a large monitoring system 1, it is sufficient that a node 10 may pass its information to another node so that the latter may convey it, directly or through other nodes, to a receiving point, illustrated for example by the mobile device 4 and/or the fixed data collection mobile station 8.

Henceforth reference will be made by sake of simplicity, without for this introducing any limitations, to the case where the wireless communication interface of the monitoring devices 10 is or comprises an active or passive RFID transponder 16.

In accordance with a preferred embodiment, the above-mentioned RFID transponder 16 comprises a PIFA (Planar Inverted F Antenna) antenna 19, for example, made as a micro-strip on a substrate 11, which for example represents a printed circuit board on which the various electronic components of the monitoring device 10 are mounted.

The RFID transponder 16 may be a component external to the processing unit 13 and operatively connected to the latter through suitable electric connections, or it may be a module provided within the processing unit 13, except for the antenna 19, which in any case would be external. In the first one of the above-mentioned embodiments, the memory 15 could be a memory, for example an EPROM, internal to the RFID transponder 16. In the other one of the above-mentioned embodiments, said memory 15 can be an external memory which the processing unit 13 accesses when the RFID transponder within the processing unit 13 receives a request from a fixed or mobile external query device 4,8. In such a case, and in the case that the RFID transponder is of the passive type, the processing unit 13 is energized, for example, to carry out the above-mentioned reading from the same internal passive RFID transponder. On the contrary, in the sampling and/or processing operations of the digital data, the processing unit 13 is supplied by the power supply system 18. Due to this reason, in the above-mentioned embodiment, the operation of the device 10 can be referred to as semi-passive, i.e., it is active during the data acquisition and processing, and it is passive when reading such data as a reply to a query by an external device 4,8. Due to the above-mentioned reason, two diodes have been illustrated in FIG. 2 between the RFID transponder 16 and the processing unit 13, and between the power supply system 18 and the processing unit 13, to the aim of pointing out that in the presence of a RFID link, the transponder 16 may supply the processing unit 13, while in the absence of such link, for the acquisition and storage of the samples, the processing unit 13 is usually supplied by the power supply system 18.

In accordance with an embodiment, the processing unit 13 is programmed to switch between two possible power consumption statuses, in which one of said statuses is a status having a relatively limited consumption compared to the other one, for example, a so-called powerdown status. In such embodiment, the processing unit 13 is such as to normally and mainly remain in the status of relatively limited consumption to switch to the other status at preset time intervals in order to sample the electric signals provided by the sensors S1-S6. For example, such sampling occurs every half hour, or every hour. Therefore, in this example it is apparent that the processing unit 13 mainly remains in the status of relatively limited energy consumption.

In accordance with an embodiment, the monitoring device 10 comprises a passive movement sensor S5 operatively connected to the processing unit 13. In accordance with an embodiment, such passive movement sensor S5 is an inertial mass sensor connected to two pins of the processing unit 13, in which a mobile mass following a handling of the monitoring device 10 is such as to determine an interrupt between the pins of the processing unit 13 in order to determine a reactivation of such processing unit 13 from a powerdown status.

The processing unit 13 is such as to switch from the relatively limited consumption status to the other status when the passive movement sensor S5 detects a movement having a width exceeding a preset threshold. In the above-mentioned embodiment, it is possible to provide that a vibration sensor and/or a mechanical shock sensor is comprised among the measurement sensors S1-S6, which is adapted to output an electric signal and in which, following said switching, the processing unit 13 is such as to sample the electric signal provided by the above-mentioned vibration and/or shock sensor and to store digital data related to the vibration and/or shock values if the latter exceed, for example, preset thresholds. In this manner, advantageously, the shock or vibration measurements are activated at each event, avoiding acquiring useless periodical measurements when the critical system is not undergoing vibrations and/or shocks.

In accordance with an embodiment, the measurement sensor S1-S6 comprises a temperature sensor. In this case, the processing unit 13 is configured and programmed to calculate the equivalent storage time of the critical system 2 at a given reference temperature, for example, at 25° C. This measurement allows understanding how much the critical system 2 has aged compared to a storage under ideal conditions; hence, it provides a measurement that is useful to know the health status of the system, hence also the residual life of the system.

In particular, in accordance with the above-mentioned embodiment, the processing unit 13 is configured and programmed to calculate the equivalent storage time of the critical system 2 at a reference temperature according to the Arrhenius law. Based on such law, it is possible to calculate an acceleration factor AF as:

AF=exp [(−E_{aA}/k)*(1/Tᵢₙₜ)-(1/T_{ref})] (1.1)

in which:
E_{aA}=is the activation energy in J/mol (values that may be programmed and that are stored in the memory) of the degradation process;
T_{ref}=reference temperature in ° K (for example, of 293.15 ° K for 20° C., or 298.15° K for 25° C.);
Tᵢₙₜ=is the current temperature within the critical system 2 in ° K;
k=is the universal gas constant (8.314472 J/mol/° K). Advantageously, the temperature Tᵢₙₜ can be a temperature esteemed based on an external temperature measurement.

The equivalent storage time T25 (in the no-limiting hypothesis that the reference temperature is 25° C.) is obtained by integrating the acceleration factor AF upon time.

Since the processing unit 13 is such as to operate in the discrete domain of sampled data, the processing unit 13 can be programmed and configured to calculate the above-mentioned integral at each step, i.e., after the acquisition of each sample, according to a recursive formula based on which the equivalent storage time T25 at the current step “t” is equal to the sum of the equivalent storage time at the previous step “t−1”, and of an additional contribution accumulated in the time interval elapsed between the previous step “t−1” and the current step “t”. Such contribution is given by the product of the sampling interval (for example, 0.5 hours) by the acceleration factor AFₜ calculated at step t, i.e.:

T25ₜ=T25ₜ₋₁+0.5AF. (1.2)

In the case that the reference temperature is 25° C., the acceleration factor AF may be calculated as exp(k*(Tc−25)/(Tc+273), in which Tc represents an estimate of the internal temperature Tᵢₙₜ obtained from the samples of the external temperature measured by the temperature sensor.

In the formula (1.1) of the acceleration factor AF, the temperature Tᵢₙₜ represents the real temperature of the critical system 2. Since, in a non-limiting embodiment, it can be supposed that such temperature depends on a first-order transfer function from the sampled temperature Ts by the processing unit 13, it is possible to show that the temperature Tc may be obtained as the scalar product between a vector Ts of samples having a predetermined length stored in the vector of samples Ts according to a FIFO storage technique, in which, at each step, i.e., at each sampling, the last acquired sample is inserted at the end, with a shift of the other samples in the vector Ts towards the first element of the vector (the sample of which is thus overwritten and leaves the vector), and a vector vet_e of real numbers, which represent exponential increment values.

In order to provide an example, it shall be supposed that:

t_sam represents the sampling interval;
T1 represents the temperature stored by the sensor and sampled;
the initial temperature within the critical system 2 is, by the sake of simplicity and without for this introducing any limitations, of 0 C.

Starting from the initial instant after the first step, i.e., after an interval t_sam, the temperature within the critical system will be T1*(1-e^{-t}^{_{—}}^{sam/T}) in which τ represents the time constant of the system. At the next step, after an interval t_sam, it shall be supposed that T2 represents the temperature stored by the sensor and sampled. The temperature interval T2-T1 will provide a contribution (T2-T1)*(1-e^{-t}^{_{—}}^{sam/T}), while T1 will provide a contribution of T1* (1-e^{-2t}^{_{—}}^{sam/T}). Therefore, at the next step, the temperature esteemed within the critical system will be T_{c}=T3*(1-e^{-t}^{_{—}}^{sam/T})+T2* (e^{-t}^{_{—}}^{sam/T}-e^{-2t}^{_{—}}^{sam/T}+T1* (e^{2t}^{_{—}}^{sam/T}-e^{-3t}^{_{—}}^{sam/T}). This represents in mathematical terms a scalar product between a vector Ts of sampled temperatures [T3 T2 T1], i.e., a vector Ts of temperature samples, and an exponential increment vector. Therefore, it has been noticed that excellent results are obtained even if the vector Ts of sampled temperatures is a vector of a reduced number of elements, for example, of about ten elements. This type of calculation allows saving processing time and dissipated power. Furthermore, it allows estimating the internal temperature of the critical system 2 from the external one, for example, from the temperature measured by the monitoring device 10 at the container 3 of the critical system 2, or generally at an external point with respect to the interior of the critical system 2.

Based on the above-mentioned description, therefore, it shall be apparent that, in accordance with an advantageous embodiment, in order to calculate the equivalent storage time, the processing unit 13 is programmed for:

sampling the signal provided by the temperature sensor to obtain a digital sample and storing it in a vector of samples Ts having a limited and preset length according to a FIFO storage technique;

at each sampling step, calculating the scalar product between said vector of samples Ts and a vector, for example, previously stored the device 10, of real numbers, which represent exponential increment values.

In a completely similar manner, if both a temperature sensor and a humidity sensor are provided, it is possible to calculate the ageing according to the Eyring-Peck-Arrhenius model (temperature-humidity combined model).

Similarly, if a vibration sensor is provided, it is possible to calculate the ageing according to the reverse power model.

In accordance with further embodiments, the monitoring device 10 is capable of monitoring ageing, hence the health status of the critical system 2, by further models such as, for example:

controlling thresholds (OS—out of specification): it is recorded if preset temperature, humidity, vibration, shock, pressure thresholds are exceeded;

turning on/off: the number of the turning on/off cycles is recorded;

operative hours: the operative hours of the relative system are recorded.

In accordance with a further embodiment, the memory unit 13 is such as to store in the memory 15 at least one vector of data that represents a histogram and the processing unit 13 comparing said digital data to thresholds is such as to store the digital data in specific elements of said vector in order to provide said histogram. It shall be noticed that, in the case that such histogram is a temperature histogram, it shall be suitable to store the T_{c} in such histogram, for example, at each step, i.e., the esteemed internal temperature of the critical system 2 in the manner described above.

With reference to the scheme of FIG. 2, the data displaying unit 20 of the monitoring device 10 is operatively connected to the processing unit 13, and it is adapted to locally display data relative to the health status of the critical system 2 and/or generally data relative to the magnitudes measured by the measurement sensors S1-S6.

The data displaying unit 20 particularly comprises bistable display 20, preferably a cholesteric display. A bistable display is a display requiring a power consumption only upon performing a refresh of the image and/or the data to be displayed thereon, i.e., basically only during the writing operation. After such operation, the image and/or data written on the display 20 remain readable for an indeterminate time, without the display 20 requiring a power supply source.

In accordance with an embodiment, the processing unit 13 is such as to update, i.e. perform a refresh of, the bistable display 20 sporadically and on occurrence of a preset condition detectable by the processing unit 13.

For example, if it is provided for displaying a datum relative to an “alarm” (for example, the caption “ALARM”) and/or “normality” (for example, the caption “GOOD”) condition on the bistable display 20, the processing unit 13 is such as to control a refresh of the datum on the bistable display 20 only following a variation of said condition from “normality” to “alarm”. In accordance with an embodiment, the displayed datum relative to the alarm condition specifies the measurement that determined the alarm, for example, displaying the datum “ALARM T” is provided for if the temperature detected by the sensor exceeds a preset threshold and/or the datum “ALARM h” is provided for if the humidity detected by the sensor exceeds a preset threshold, etc. In accordance with an embodiment, the displayed datum relative to the alarm condition is displayed even when the conditions that determined the alarm cease, until performing a forced reset, locally or remotely, by an operator.

In accordance with a further example, if the displaying on the bistable display 20 a datum 22 relative to a magnitude acquired by the sensor S1-S6, such as, for example, temperature, is provided for, the processing unit 13 is such as to control a refresh of the bistable display 20 only following a variation of said displayed datum 22 or said acquired magnitude exceeding a preset threshold value.

The bistable display 20 advantageously allows an inspector or operator getting an immediate indication of the conditions of a critical system during a normal operation of the monitoring device 10 without this requiring a significant power consumption. Furthermore, in the case of a failure of the monitoring device 10, for example, of the processing unit 13, it further advantageously allows having a piece of information about which the status was and/or which the storing conditions of the critical system were before the failure, also, but not only, in order to try and trace the cause of that failure.

From the description given above, it is possible to understand how a monitoring device of the type described above fully achieves the preset objects. Field experimental tests showed that a monitoring device of the type described above allows carrying out with a considerable autonomy an accurate and reliable monitoring of the health status of limited life critical systems.

It shall be apparent that, to the above-described monitoring device, those of ordinary skill in the art, in order to meet contingent, specific needs, will be able to make a number of modifications and variations, all of which anyhow falling within the protection scope of the invention, as defined by the following claims.

1. A device for monitoring the health status of a limited life critical system, comprising:
at least one measurement sensor adapted to measure a magnitude adapted to affect the health status of the critical system by outputting a signal carrying information relative to such magnitude;
at least one processing unit operatively connected to the sensor and adapted to receive and sample said signal to provide digital data relative to such magnitude;
at least one memory adapted to store said digital data or digital data obtained therefrom through said processing unit;
a power supply system of the measurement sensor and the processing unit;
a communication interface adapted to transmit said stored digital data;
a data displaying unit, comprising a bistable display, operatively connected to the processing unit and adapted to locally display data relative to the health status of the critical system and/or data relative to said magnitude.

2. The device for monitoring the health status of a limited life critical systems according to claim 1, wherein the processing unit is programmed to control a refresh of the bistable display sporadically and on occurrence of a preset condition detectable by the processing unit.

3. The device for monitoring the health status of a limited life critical system according to claim 2, wherein the bistable display is adapted to display a datum relative to an “alarm” and/or “normality” condition, and wherein the processing unit is such as to control a refresh of said datum on the bistable display only following a variation of said condition from “normality” to “alarm”.

4. The device for monitoring the health status of a limited life critical system according to claim 2, wherein the bistable display is adapted to display a datum relative to the magnitude measured by the sensor, and wherein the processing unit is such as to control a refresh of the bistable display only following a variation of said displayed datum or said measured magnitude exceeding a preset threshold value.

5. The device for monitoring the health status of a limited life critical system according to claim 1, wherein the communication interface comprises a passive RFID transponder adapted to receive a request by an external query RFID device and to provide as a reply said digital data to the query device by accessing the memory.

6. The monitoring device according to claim 1, wherein the processing unit is programmed to switch between two energy consumption statuses, wherein one of said statuses is a consumption status having a relatively limited consumption compared to the other one, the processing unit being such as to normally and mainly remain in said status of relatively limited consumption to switch to the other status at preset time intervals in order to sample said signal.

7. The monitoring device according to claim 6, comprising a passive movement sensor operatively connected to the processing unit, wherein the processing unit is such as to switch from the relatively limited consumption status to the other status when the passive movement sensor detects a movement having a width exceeding a preset threshold.

8. The monitoring device according to claim 7, wherein said at least one measurement sensor comprises a vibration and/or mechanical shock sensor adapted to output an electric signal, and wherein, following said switching, the processing unit is such as to sample said electric signal provided by the vibration and/or shock sensor.

9. The monitoring device according to claim 1, wherein the measurement sensor comprises a temperature sensor, wherein the digital data comprise data related to the storage temperature of the critical system, and wherein the processing unit is programmed to calculate the equivalent storage time at a reference temperature by calculating an acceleration factor according to the Arrhenius law.

10. The monitoring device according to claim 9, wherein, in order to calculate said equivalent storage time, the processing unit is programmed for:
sampling said signal to obtain a digital sample and storing it in a vector of samples having a predetermined length according to a FIFO storage technique;
upon each sampling, carrying out the scalar product between said vector of samples and a vector of real numbers, which represent exponential increment values.

11. The monitoring device according to claim 1, wherein the processing unit is such as to store in said memory at least one vector of data that represents a histogram, and wherein the processing unit, by comparing said digital data to thresholds, is such as to store the digital data in specific elements of said vector in order to provide said histogram usable by said external query RFID device.

12. A container for a critical system comprising a containment body adapted to house a critical system therein, and characterized in that it comprises at least one monitoring device according to claim 1, which is mechanically coupled to said containment body.
